(19) United States
(12) Patent Application Publication
(10) Pub. No.: US 2011/0086635 A1
(43) Pub. Date: Apr. 14, 2011

(54) Method And Apparatus For Utilizing Mobility State Information

(75) Inventor: Heidrun Grob-Lipski, Starzach (DE)

(73) Assignee: Alcatel-Lucent USA Inc., Murray Hill, NJ (US)

(21) Appl. No.: 12/900,647

(22) Filed: Oct. 8, 2010

Related U.S. Application Data
(60) Provisional application No. 61/250,249, filed on Oct. 9, 2009.

(51) Int. Cl. H04W 24/00; H04W 36/00

(52) U.S. Cl. 455/423; 455/436

(57) ABSTRACT

A network node receives (101) from a user equipment (UE), an indication of a mobility state of the UE. The network node utilizes (102) the mobility state of the UE to adapt a time to trigger (TTT) value for use in improved handover operation. Depending on the embodiment, the network node may also track handover failures (such as failures due to missing handover commands) and handover ping pongs and use this information to determine a TTT value that achieves a reduction in either a number of handover failures due to missing handover commands or a number of handover ping pongs or possibly both.

### REFERENCE(S) TO RELATED APPLICATION(S)

The present application claims priority from a provisional application Ser. No. 61/250,249, entitled “METHOD AND APPARATUS FOR UTILIZING MOBILITY STATE INFORMATION,” filed Oct. 9, 2009, which is commonly owned and incorporated herein by reference in its entirety.

### FIELD OF THE INVENTION

The present invention relates generally to communications and, in particular, to utilizing mobility state information in wireless networks.

### BACKGROUND OF THE INVENTION

This section introduces aspects that may help facilitate a better understanding of the inventions. Accordingly, the statements of this section are to be read in this light and are not to be understood as admissions about what is prior art or what is not prior art.

Currently, network operators are pushing 3GPP standards to include features that support the Self-Organizing Networks (SON) functionality for LTE bases on so-called use-cases (TR 36.902 [1]). One use case, Mobility robustness optimization, is targeting the enhancement of handover procedures, e.g., reducing failures originated by missing handover command messages, decreasing ping pong and access failures, lowering the number of radio link failures prior to or immediately after handover, avoiding cell spots etc. Therefore, new approaches and techniques that are able to further mobility robustness optimization are needed and would advance mobile communications generally.

### BRIEF DESCRIPTION OF THE DRAWINGS

FIG. 1 is a logic flow diagram of functionality performed by a network node in accordance with various embodiments of the present invention.

FIG. 2 is a logic flow diagram of functionality performed by user equipment in accordance with various embodiments of the present invention.

FIG. 3 is a logic flow diagram of functionality performed by a network node in accordance with various embodiments of the present invention.

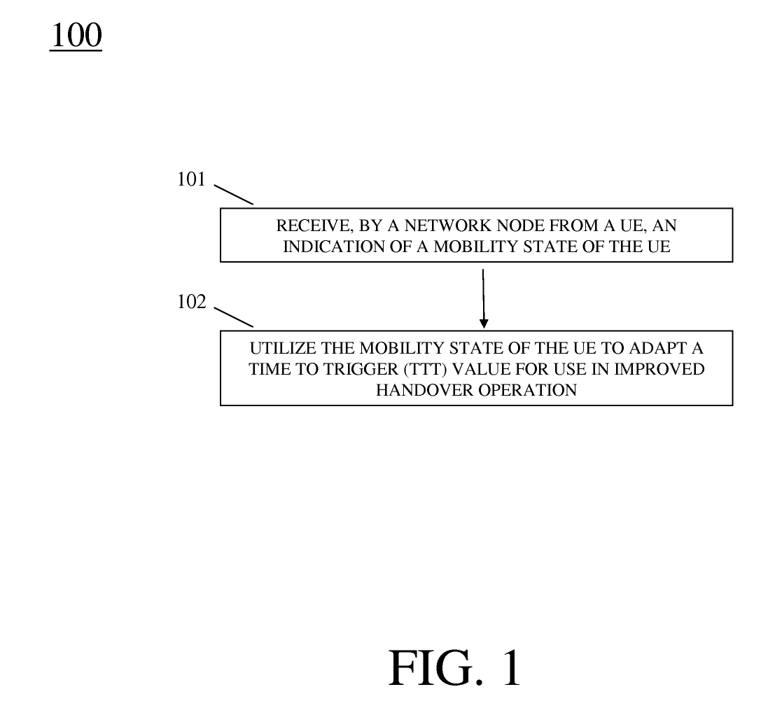

Specific embodiments of the present invention are disclosed below with reference to FIGS. 1-3. Both the description and the illustrations have been drafted with the intent to enhance understanding. For example, the dimensions of some of the figure elements may be exaggerated relative to other elements, and well-known elements that are beneficial or even necessary to a commercially successful implementation may not be depicted so that a less obstructed and a more clear presentation of embodiments may be achieved. In addition, although the logic flow diagrams above are described and shown with reference to specific steps performed in a specific order, some of these steps may be omitted or some of these steps may be combined, sub-divided, or reordered without departing from the scope of the claims. Thus, unless specifically indicated, the order and grouping of steps is not a limitation of other embodiments that may lie within the scope of the claims.

Simplicity and clarity in both illustration and description are sought to effectively enable a person of skill in the art to make, use, and best practice the present invention in view of what is already known in the art. One of skill in the art will appreciate that various modifications and changes may be made to the specific embodiments described below without departing from the spirit and scope of the present invention. Thus, the specification and drawings are to be regarded as illustrative and exemplary rather than restrictive or all-encompassing, and all such modifications to the specific embodiments described below are intended to be included within the scope of the present invention.

### DETAILED DESCRIPTION OF EMBODIMENTS

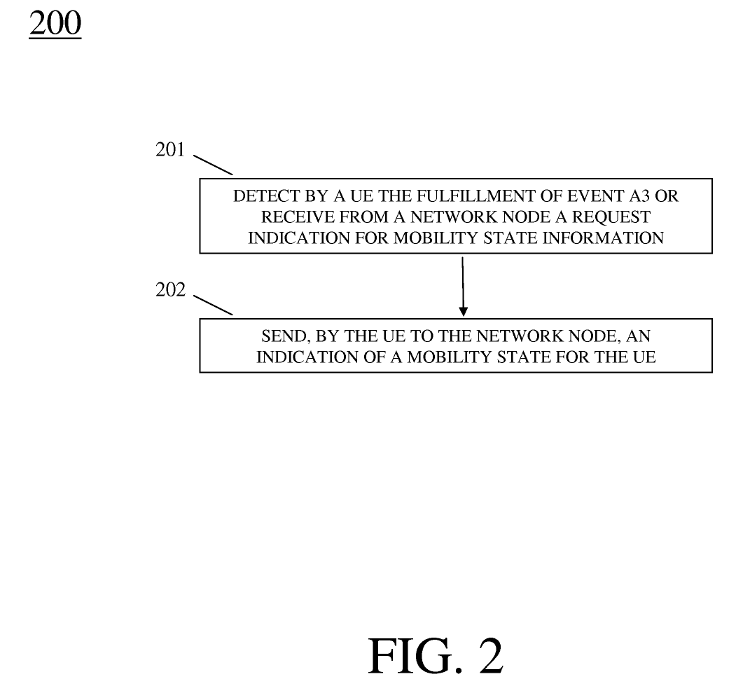

The present invention can be more fully understood with reference to FIGS. 1-3. FIGS. 1 and 2 are logic flow diagrams of functionality performed in accordance with various embodiments of the present invention. Diagrams 100 and 200 serve as a good generalization of many of the embodiments described in detail below. Thus, they are referenced now to provide a preview of the general approach to handover improvement followed by many embodiments of the present invention.

In diagram 100, a network node receives (101) from a user equipment (UE), an indication of a mobility state of the UE. The network node utilizes (102) the mobility state of the UE to adapt a time to trigger (TTT) value for use in improved handover operation. Depending on the embodiment, the network node may also track handover failures (such as failures due to missing handover commands) and handover ping pongs and use this information to determine a TTT value that achieves a reduction in either a number of handover failures due to missing handover commands or a number of handover ping pongs or possibly both. Depending on the embodiment, the network node may utilize a gradient balancing algorithm and/or a genetic search algorithm to adapt a more optimal TTT value for each mobility state.

In diagram 200, a UE either detects (201) the fulfillment of a handover event A3 or receives from a network node a request indication for mobility state information. In response to either the detection or request, the UE sends an indication of a mobility state for the UE to the network node. Depending on the embodiment, the UE may send the mobility state indication in a MeasurementReport message. In some embodiments, the UE, depending on whether the trigger is the detection or the request, may send the mobility state indication in the same MeasurementReport message as it sends an indication of an A3 event or in the next MeasurementReport message sent by the UE after receiving a request indication from the network node.

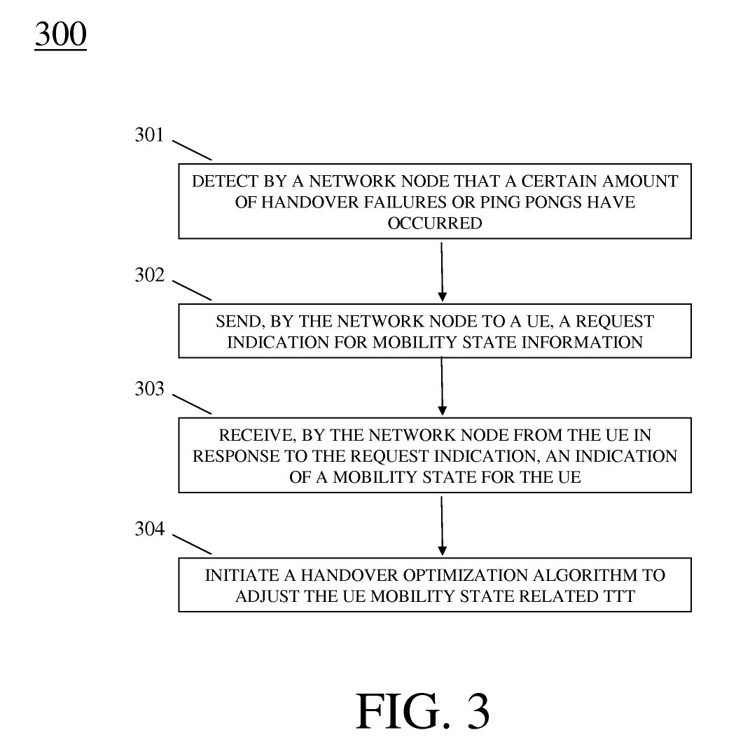

To provide a greater degree of detail in making and using various aspects of the present invention, a description of our approach to improving the performance of handover and a description of certain, quite specific, embodiments follows for the sake of example. FIG. 3 is referenced in an attempt to illustrate an example of specific embodiments of the present invention and/or how some specific embodiments may operate/perform.

Below is a list of references that are referred to throughout the present specification:

[1] 3GPP TR 36.902, V1.0.1, Evolved Universal Terrestrial Radio Access Network (E-UTRAN); Self-configuring and self-optimizing network use cases and solutions (Release 8), September 2008.

[2] TS 36.331, V8.4.0, E-UTRA RRC Protocol specification (Release 8), December 2008.

[3] 3GPP TS 36.300, V8.7.0, E-UTRA and E-UTRAN; Overall description; Stage 2 (Release 8), December 2008.

[4] 3GPP TS 36.423, V8.4.0, E-UTRAN X2 application protocol (X2AP) (Release 8), December 2008.

[5] R2-080819, Measurement report on UE mobility state, Samsung, February 2008.

[6] R2-081760, UE mobility state reporting, InterDigital, April 2008.

For the generation of an event A3, the UE monitors the RSRP (Reference Signal Received Power) or RSRQ (Reference Signal Received Quality) of the neighbor cells and of the source cell. It checks whether the measured result of the neighbor cell n (Mₙ) exceeds the measured result of the source cell (Mₛ) with a predefined handover margin Off and probably a cell individual offset Ocn [2]:

Mₙ+Ocn>Mₛ+Off

If the condition holds for a predefined time to trigger (TTT_{Off}), the UE creates the event A3.

As soon as an event A3 has been generated, the UE includes this event in a MeasurementReport message and forwards it to the source eNB. If the source eNB decides for handover it sends a HandoverRequest message via an X2 interface to the target eNB. The source eNB waits for the X2 HandoverRequestAck message from the target eNB. Then it forwards the HandoverCommand (RRCHandoverReconfiguration) message to the UE, which commands the UE to perform handover [3].

It can be observed that there is a strong relationship between the UE speed and the failures due to missing handover command messages and the amount of ping ponging. Roughly speaking, if the TTT_{Off} is the same for all UEs, the number of handover command failures increases and the number of ping pongs decrease for fast moving UEs and vice versa. During standardization [2], the three mobility state levels “normal”, “medium” and “high” have been introduced in order to cope with the speed dependant occurrences of failures and ping pongs.

In connected mode, the UE is counting handovers in order to identify the mobility state. It multiplies the timeToTrigger, defined for the normal mobility state, with factor timeToTriggerSF-High, if it detects the mobility state “high” and multiplies the timeToTrigger with the factor timeToTriggerSF-Medium, if it detects the mobility state “medium.” Therewith, the UE autonomously adjusts the TTT_{Off} parameter. This leads to a number of handover command failures and to a number of ping pongs depending on the current TTT_{Off}, which is not known to the eNB.

The source eNB may derive the UE mobility state from the UE speed calculations based on the Timing Advance, which is not in line with the currently standardized UE mobility state selection performed in the UE. Alternatively, the source eNB may determine the UE mobility state by counting handovers according to the UE History Information transmitted in the X2 HandoverRequest message as soon as the UE initiates handover [4]. However, this practice may lead to asynchronous UE mobility state categorizations. Apart from that, the procedure for UE mobility state identification is quite questionable, as interdependencies between TTT_{Off} adjustment, failure and ping pong rates and a number of handovers occur.

The documents R2-080819[5] and R2-081760[6] proposed that the eNB should know the mobility state of the UE for an efficient RRM and scheduling method, to determine the UE dedicate UL sync timer value or to schedule localized or distributed radio blocks. Another point that was mentioned was that if the network was aware of the mobility state of the UE, it might be able to use that information to decide when to initiate a handover. It has been proposed that a measurement report should be defined to signal the UE mobility state or to add the mobility state to the existing measurement reports.

Various embodiments are proposed to introduce communication between the source eNB and the UE to enable the source eNB to identify the mobility state of the UE in order to perform HO parameter optimization. The request is performed by introducing an additional parameter, which can be included within a data packet or within an already existing 3GPP message. The reporting of the UE mobility state may be done by introducing an additional parameter within an already specified 3GPP message.

In order to obtain correct statistics and for initializing the right consequences, it is important to have the information about the selected UE mobility state available in the source eNB. For this reason, the source eNB should have the ability to request the UE with a short notice within a data packet or within an already existing message to include the UE mobility state into the next MeasurementReport so that the eNB could synchronize its UE mobility state for correct collection of SON statistics.

At the moment, the MeasurementReport message, currently defined in the 3GPP RRC specification [2], does not include any information about the selected UE mobility state. So, standardization efforts should be made in order to include the UE mobility state into the MeasurementReport message. The UE then has to send a short notice about the selected mobility state in the UE MeasurementReport. The notice about the UE mobility state can always be transmitted in the MeasurementReport as soon as event A3 is fulfilled.

During measurement configuration, the source eNB also configures the speed dependent parameters. Hence, with the information about the UE mobility state, the eNB is able to deduce the TTT_{Off}, which caused the preceding MeasurementReport message. Beyond this, with the notice about the UE mobility state in the MeasurementReport message, the eNBs are able to administrate comprehensive SON statistics, including failures originated by missing handover command messages, ping pong and access failures, radio link failures prior to or immediately after handover, cell spots etc. Additionally, the eNBs are able to initiate appropriate and enhanced measures, e.g. they are able to react immediately to the UE mobility state notice in the MeasurementReport message.

The handover parameter optimization process enables the adaptation of the TTT with the aim to find an optimum TTT that minimizes the number of failures due to missing handover command (HOCF) in the source eNB and concurrently the number of ping pongs. The handover parameter optimization algorithm adjusts the TTT value separately for each mobility state, whereas the adaptation process will always be a tradeoff between the minimization of HOCFs and the minimization of ping pong. For each mobility state, a separate adaptation process is initiated.

Principally, there are two methods for handover parameter optimization, the gradient balancing and the genetic search algorithm. The gradient balancing algorithm has the advantage that the search for an optimum TTT value is done based on statistics either from previous simulation runs or from practical experience. From these statistics, conclusions are drawn concerning the course of the tradeoff between HOCF rate and Ping pong rate depending on different TTT values.

The big benefit of this method is that the algorithm searches for an optimum value in the background. The algorithm outputs TTT values for application lying quite near to the optimal TTT until convergence to the optimum TTT or to a TTT that is very near to the optimum. TTT values far apart from the optimum do not need to be applied as the quality of each TTT is estimated based on the statistics. So, a lot of HOCFs and Ping pongs will not be produced in vain during the optimization process only for judging the proposed TTT. One problem with gradient balancing is that the method needs a convex course of the tradeoff curve. Measurement inaccuracies can be compensated for by quadratic regression, which produces a convex course of the tradeoff curve.

The second method finds the optimum value with genetic search. This method can even be applied if the course of the tradeoff curve is completely unknown and if each course of the tradeoff curve is possible. Starting from an initial TTT generation, the genetic algorithm produces TTT offspring. The quality of these offspring has to be evaluated. As this algorithm acts on the assumption, that the course of the tradeoff curve is not known, the quality of these offspring can not be estimated and has to be produced by applying them in the handover decision algorithm. However, this implicates that also TTTs apart from the optimum TTT value have to be applied in the handover decision algorithm. As a big benefit the genetic search assumes that the tradeoff may posses multiple local optima. In order to find the global optimum the genetic search applies ascertained genetic operators.

The handover optimization algorithm can also combine both methods. At system start, the monitored course of the tradeoff curve may fluctuate strongly. Moreover, it may be desired to gather experienced data about HOCF and Ping pong from the real system. So, the handover parameter optimization applies the genetic search algorithm at system launch in order to generate statistics from practical experience and to find the optimum TTT in this unstable situation. If the course of the tradeoff curve is available and observed to be stable, the gradient balancing method can be applied.

An example of handover parameter optimization embodiments is depicted in diagram 300 of FIG. 3. HO optimization is initiated as soon as a certain amount of failures or ping pongs have occurred (301). At this moment it is necessary for the source eNB to find out, whether the information the source eNB has stored about the UE mobility state is correct. This could be done by sending (302) a request to the UE in order to trigger the UE to include the UE mobility state information (303) into the next MeasurementReport. With this information, the source eNB is able to synchronize the UE mobility state and the related statistics.

If the UE mobility state information of the UE sent in the MeasurementReport is the same as the UE mobility state stored in the source eNB, the HO optimization algorithm will be initiated (304) to adjust the UE mobility state related TTT. If the UE mobility state information of the UE sent in the MeasurementReport is different from the UE mobility state stored in the source eNB, the UE mobility state is corrected so that the statistics can be collected for the correct UE mobility state.

The detailed and, at times, very specific description above is provided to effectively enable a person of skill in the art to make, use, and best practice the present invention in view of what is already known in the art. In the examples, the present invention is described in the context of specific architectures, specific system configurations and specific wireless signaling technologies for the purpose of illustrating possible embodiments and a best mode for the present invention. Thus, the examples described should not be interpreted as restricting or limiting the scope of the broader inventive concepts.

Benefits, other advantages, and solutions to problems have been described above with regard to specific embodiments of the present invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

As used herein and in the appended claims, the term “comprises,” “comprising,” or any other variation thereof is intended to refer to a non-exclusive inclusion, such that a process, method, article of manufacture, or apparatus that comprises a list of elements does not include only those elements in the list, but may include other elements not expressly listed or inherent to such process, method, article of manufacture, or apparatus. The terms a or an, as used herein, are defined as one or more than one. The term plurality, as used herein, is defined as two or more than two. The term another, as used herein, is defined as at least a second or more. Unless otherwise indicated herein, the use of relational terms, if any, such as first and second, top and bottom, and the like are used solely to distinguish one entity or action from another entity or action without necessarily requiring or implying any actual such relationship or order between such entities or actions.

The terms including and/or having, as used herein, are defined as comprising (i.e., open language). The term coupled, as used herein, is defined as connected, although not necessarily directly, and not necessarily mechanically. Terminology derived from the word “indicating” (e.g., “indicates” and “indication”) is intended to encompass all the various techniques available for communicating or referencing the object/information being indicated. Some, but not all, examples of techniques available for communicating or referencing the object/information being indicated include the conveyance of the object/information being indicated, the conveyance of an identifier of the object/information being indicated, the conveyance of information used to generate the object/information being indicated, the conveyance of some part or portion of the object/information being indicated, the conveyance of some derivation of the object/information being indicated, and the conveyance of some symbol representing the object/information being indicated.

What is claimed is:

1. A method comprising:
receiving, by a network node from a user equipment (UE), an indication of a mobility state of the UE;
utilizing, by the network node, the mobility state of the UE to adapt a time to trigger (TTT) value for use in improved handover operation.

2. The method as recited in claim 1, further comprising
sending, by the network node to the UE, a request indication for the mobility state information that the network node received.

3. The method as recited in claim 2, wherein receiving the indication of the mobility state of the UE comprises
receiving the indication of the mobility state of the UE in the next MeasurementReport message received by the network node from the UE after sending the request indication.

4. The method as recited in claim 1, further comprising
tracking handover failures and handover ping pongs.

5. The method as recited in claim 1, wherein utilizing the mobility state of the UE to adapt a TTT value comprises
utilizing the mobility state of the UE to adapt a TTT value for a given mobility state.

6. The method as recited in claim 1, wherein utilizing the mobility state of the UE to adapt a TTT value comprises
determining a TTT value that achieves a reduction in at least one of a number of handover failures due to missing handover commands (HOCF) and a number of handover ping pongs.

7. The method as recited in claim 1, wherein utilizing the mobility state of the UE to adapt a TTT value comprises
utilizing at least one of a gradient balancing algorithm and a genetic search algorithm to adapt a TTT value.

8. An article of manufacture comprising a processor-readable storage medium storing one or more software programs which when executed by one or more processors performs the steps of the method of claim 1.

9. A method comprising:
sending, by a network node to a user equipment (UE), a request indication for mobility state information;
receiving, by the network node from the UE in response to the request indication, an indication of a mobility state for the UE.

10. The method as recited in claim 9, further comprising
tracking handover failures and handover ping pongs.

11. The method as recited in claim 9, further comprising
prior to sending the request indication, detecting one of a number of handover failures exceeding a failure threshold or a number of handover ping pongs exceeding a ping pong threshold.

12. The method as recited in claim 9, further comprising
utilizing, by the network node, the mobility state of the UE to adapt a mobility state related time to trigger (TTT) value for use in improved handover operation.

13. The method as recited in claim 12, wherein utilizing the mobility state of the UE to adapt a TTT value comprises
utilizing the mobility state of the UE to adapt a TTT value for a given mobility state.

14. The method as recited in claim 12, wherein utilizing the mobility state of the UE to adapt a TTT value comprises
determining a TTT value that achieves a reduction in at least one of a number of handover failures due to missing handover commands (HOCF) and a number of handover ping pongs.

15. The method as recited in claim 12, wherein utilizing the mobility state of the UE to adapt a TTT value comprises
utilizing at least one of a gradient balancing algorithm and a genetic search algorithm to adapt a TTT value.

16. A method comprising:
performing by a user equipment (UE) one of detecting the fulfillment of event A3 or receiving from a network node a request indication for mobility state information;
sending, by the UE to the network node in response to the step of performing, an indication of a mobility state for the UE.

17. The method as recited in claim 16, wherein sending the indication of the mobility state for the UE comprises
sending the indication of the mobility state for the UE in a MeasurementReport message.

18. The method as recited in claim 17, wherein sending the indication of the mobility state for the UE in the MeasurementReport message comprises
sending the indication of the mobility state for the UE in the MeasurementReport message along with an indication of an A3 event.

19. The method as recited in claim 16, wherein sending the indication of the mobility state for the UE comprises
sending the indication of the mobility state for the UE in the next MeasurementReport message sent by the UE after receiving the request indication.

20. An article of manufacture comprising a processor-readable storage medium storing one or more software programs which when executed by one or more processors performs the steps of the method of claim 16.
